(19) United States
(12) Patent Application Publication
(10) Pub. No.: US 2021/0212271 A1
(43) Pub. Date: Jul. 15, 2021

(54) HIGH DENSITY INDOOR FARMING APPARATUS, SYSTEM AND METHOD

(71) Applicant: The Farm Works Technologies, LLC, Elkins Park, PA (US)

(72) Inventor: Jack Griffin, Philadelphia, PA (US)

(73) Assignee: The Farm Works Technologies, LLC, Elkins Park, PA (US)

(21) Appl. No.: 17/213,909

(22) Filed: Mar. 26, 2021

Related U.S. Application Data
(63) Continuation of application No. 16/110,399, filed on Aug. 23, 2018, now abandoned.
Application No. 16/110,399 is a continuation-in-part of application No. 15/472,106, filed on Mar. 28, 2017, now abandoned.
(60) Provisional application No. 62/549,053, filed on Aug. 23, 2017.
(60) Provisional application No. 62/345,621, filed on Jun. 3, 2016.

(51) Int. Cl. A01G 9/24; A01G 31/06; A01G 9/26

(52) U.S. Cl. CPC A01G 9/247; A01G 2031/006; A01G 9/26; A01G 31/06

(57) ABSTRACT

An indoor farming system includes a water-based nutrient bath resident in a tank and a pump for pumping the bath from the tank upwardly through a plurality of pipes to at least one divided high-density table comprising growing crops resting in at least one float. The plurality pipes includes at least one valve suitable to shut off the bath per each of the high density tables. At least one non-block drain is coupled to the at least one divided high-density table. The bath turbulently flows respectively across the at least one divided high-density table, down the at least one non-block drain, and back into the tank that includes the nutrient bath. A lighting system provides moving light from points above the growing crops.

### CROSS-REFERENCE TO RELATED APPLICATIONS

This application is a continuation-in-part of U.S. patent application Ser. No. 16/110,399, filed on Aug. 23, 2018, entitled “HIGH DENSITY INDOOR FARMING APPARATUS, SYSTEM AND METHOD,” which claimed priority to U.S. Provisional Application Ser. No. 62/549,053, filed on Aug. 23, 2017, entitled “HIGH DENSITY INDOOR FARMING APPARATUS, SYSTEM AND METHOD,” a continuation-in-part of U.S. patent application Ser. No. 15/472,106, filed on Mar. 28, 2017, entitled “HIGH DENSITY INDOOR FARMING APPARATUS, SYSTEM, AND METHOD,” which claimed priority to U.S. Provisional Application No. 62/345,621, filed on Jun. 3, 2016, and further claims benefit of U.S. Provisional Application Ser. No. 62/567,408, filed on Oct. 3, 2017, entitled “HIGH DENSITY INDOOR FARMING APPARATUS, SYSTEM AND METHOD,” and U.S. Provisional Application Ser. No. 62/572,217, entitled “HIGH DENSITY INDOOR FARMING APPARATUS, SYSTEM AND METHOD,” each of which is incorporated herein by reference in its entirety.

### FIELD

The present disclosure is directed generally to methods and systems of indoor farming, and more particularly is directed to high density indoor farming apparatuses, systems and methods.

### BACKGROUND

Hydroponic farming includes the practice of producing food and other plants (e.g., medicinal) without soil, using mineral nutrient solutions. One form of hydroponic farming, vertical farming, includes vertically stacked, vertically inclined surfaces configured for hydroponic farming. Current hydroponic and/or vertical farming systems suffers from a variety of issues. For example, current hydroponic and/or vertical farming systems lack sufficient density for farming, requiring higher vertical stacks and/or a greater number of stacks than is currently feasible. Current systems further have insufficient or improper lighting, need to be cleaned on a frequent basis, and have a lack of crop health, among other issues.

### SUMMARY

In various embodiments, an indoor farming system is disclosed. The indoor farming system includes a water-based nutrient bath resident in a tank and a pump for pumping the bath from the tank upwardly through a plurality of pipes to at least one divided high-density table comprising growing crops resting in at least one float. The plurality pipes includes at least one valve suitable to shut off the bath per each of the high density tables. At least one non-block drain is coupled to the at least one divided high-density table. The bath turbulently flows respectively across the at least one divided high-density table, down the at least one non-block drain, and back into the tank that includes the nutrient bath. A lighting system provides moving light from points above the growing crops.

### BRIEF DESCRIPTION OF THE FIGURES

The present disclosure is illustrated by way of example and not limitation in the figures of the accompanying drawings, in which like references indicate similar elements and in which:

FIG. 1 illustrates a front perspective view of a vertical farming system, in accordance with some embodiments;

FIG. 2 illustrates a side perspective view of the vertical farming system of FIG. 1, in accordance with some embodiment;

FIG. 3A illustrates a front view of flow table of the vertical farming system of FIG. 1, in accordance with some embodiments;

FIG. 3B illustrates a side perspective view of the flow table of FIG. 3A, in accordance with some embodiments;

FIG. 4A illustrates a first float board sized and configured to be received within an opening defined by the flow table of FIG. 3A, in accordance with some embodiments;

FIG. 4B illustrates the first float board of FIG. 4A having a growth medium disposed within at least one hole defined in the first float board, in accordance with some embodiments;

FIG. 5 illustrates a second float board sized and configured to be received within an opening defined by the flow table of FIG. 3A, in accordance with some embodiments;

FIG. 6 illustrates a light enclosure of the vertical farming system of FIG. 1, in accordance with some embodiments;

FIG. 7 illustrates a lighting system including the light enclosure of FIG. 6, in accordance with some embodiments;

FIG. 8 illustrates a lighting system configured to adjust a position of a light source in a first axis parallel to a plane of a flow table and a second axis perpendicular to the plane of the flow table;

FIG. 9 illustrates a system diagram of a modular vertical farming system, in accordance with some embodiments;

FIG. 10 illustrates a Venturi pressurized system of the modular vertical farming system of FIG. 9, in accordance with some embodiments;

FIG. 11 illustrates a modular portion of the Venturi pressurized system of FIG. 10, in accordance with some embodiments;

FIG. 12A illustrates a first spray bar configured for use in the vertical farming system of FIG. 9 including a slit extending lengthwise on at least one tangent point on the first spray bar, in accordance with some embodiments;

FIG. 12B illustrates a cross-sectional view of the first spray bar of FIG. 12A, in accordance with some embodiments

FIG. 12C illustrates a second spray bar configured for use in the vertical farming system of FIG. 9 including a plurality of openings formed along a first side of the second spray bar, in accordance with some embodiments;

FIG. 13 illustrates a tank cover for covering a water tank of the vertical farming system of FIG. 1 or 9, in accordance with some embodiments;

FIG. 14A illustrates a rotatable water inlet configured to provide modular attachment between a flow table and a water tank of the vertical farming systems of FIG. 1 or 9, in accordance with some embodiments;

FIG. 14B illustrates a rotatable drain coupled to a flow table configured for modular attachment within the vertical farming system of FIG. 9, in accordance with some embodiments;

FIG. 15 illustrates a float board having a plurality of openings sized and configured to receive mature plants therein, in accordance with some embodiments; and

FIG. 16 illustrates a vertical farming growth facility including a plurality of vertical farming systems, in accordance with some embodiments.

### DETAILED DESCRIPTION

It is to be understood that the figures and descriptions of the present disclosure have been simplified to illustrate elements that are relevant for a clear understanding of the discussed embodiments, while eliminating, for the purpose of clarity, many other elements found in known apparatuses, systems, and methods. Those of ordinary skill in the art may thus recognize that other elements and/or steps are desirable and/or required in implementing the disclosure. However, because such elements and steps are known in the art, and because they consequently do not facilitate a better understanding of the disclosure, for the sake of brevity a discussion of such elements and steps is not provided herein. Nevertheless, the disclosure herein is directed to all such elements and steps, including all variations and modifications to the disclosed elements and methods, known to those skilled in the art.

Exemplary embodiments are provided so that this disclosure will be thorough, and will fully convey the scope to those who are skilled in the art. Numerous specific details are set forth, such as examples of specific components, devices, and methods, to enable a thorough understanding of embodiments of the present disclosure. It will be apparent to those skilled in the art that specific details need not be employed, that is, that the exemplary embodiments may be embodied in many different forms and thus should not be construed to limit the scope of the disclosure. For example, in some exemplary embodiments, well-known processes, well-known device structures, and well-known technologies are not described in detail.

The terminology used herein is for the purpose of describing particular example embodiments only and is thus not intended to be limiting. As used herein, the singular forms “a”, “an” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof.

As to the methods discussed herein, the method steps, processes, and operations described herein are not to be construed as necessarily requiring their performance in the particular order discussed or illustrated, unless specifically identified as having an order of performance. It is also to be understood that additional or alternative steps may be employed.

When an element or layer is referred to as being “on”, “atop”, “engaged to”, “connected to,” “coupled to,” or a like term or phrase with respect to another element or layer, it may be directly on, engaged, connected or coupled to the other element or layer, or intervening elements or layers may be present. In contrast, when an element is referred to as being “directly on,” “directly engaged to”, “directly connected to”, “directly atop”, or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another element, component, region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the exemplary embodiments.

The various exemplary embodiments will be described herein below with reference to the accompanying drawings. In the following description and the drawings, well-known functions or constructions are not shown or described in detail since they may obscure the disclosed embodiments with the unnecessary detail.

In various embodiments, an apparatus, system, and method for high density vertical farming are disclosed.

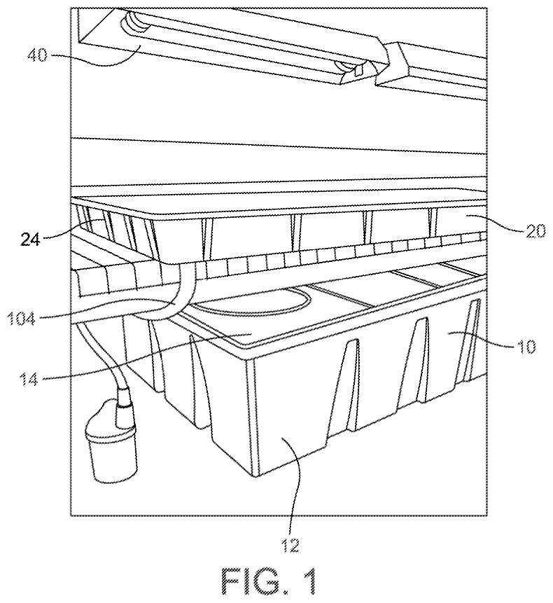

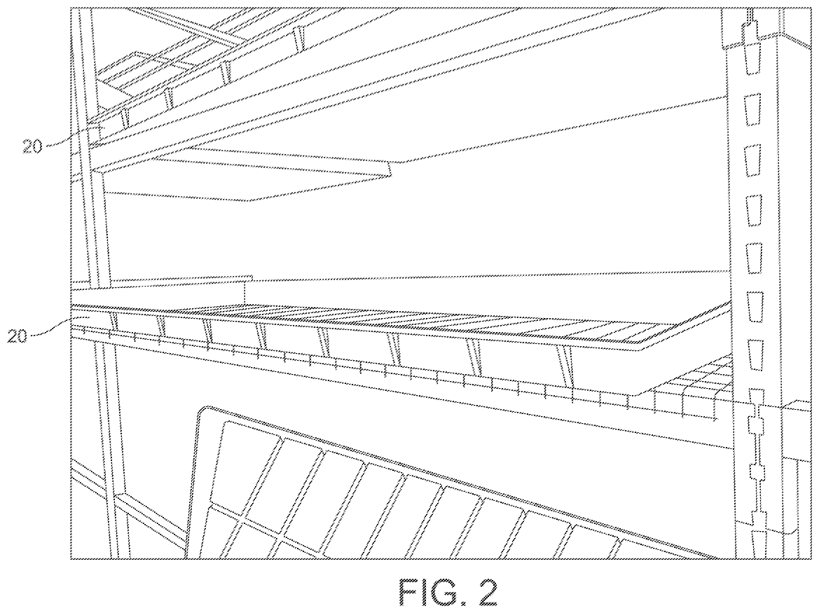

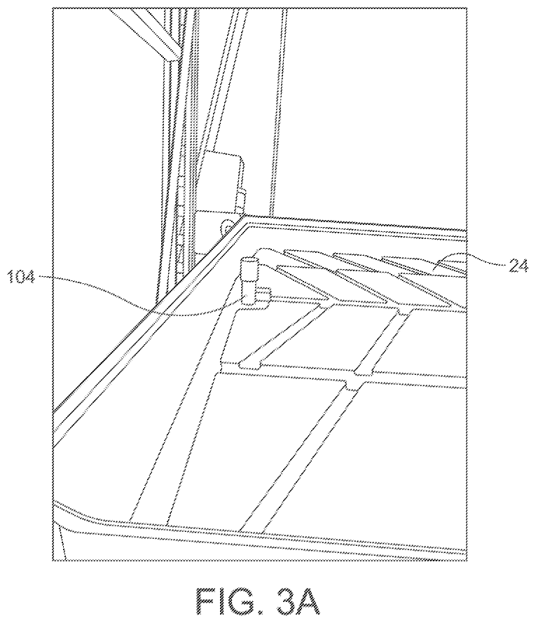

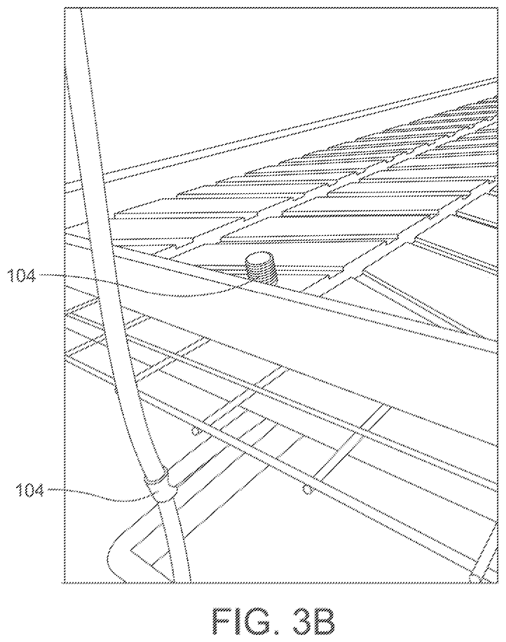

FIGS. 1-3 illustrate a vertical farming system 2 including a plurality of flow tables 20, in accordance with some embodiments. The flow tables 20 are arranged in a stacked configuration with one or more flow tables 20 being positioned above and/or below each of the other flow tables 20 in the vertical farming system 2. The flow tables 20 can include an ebb and flow water system, as discussed in greater detail below. The vertical farming system 2 includes a water-based nutrient solution 10 resident in a tank 12. The tank 12 can include any suitable volume, such as for example, at least 250 gallons, at least 500 gallons, etc. In some embodiments, the tank 12 includes an environmentally sealed tank. A pump 14 is positioned within the tank 12 and is configured to pumping the water-based nutrient solution from the tank 12 to each of the vertically stacked flow tables 20. Although embodiments are discussed herein including a tank 12 containing a water-based nutrient solution 10, it will be appreciated that the system can include multiple tanks, such as, for example, a first tank containing a nutrient solution (and/or nutrient source) and a second tank containing water, which may be separately and/or jointly provided to the flow tables 20.

In various embodiments, the vertical farming system can include between two and eight levels of vertically stacked flow tables 20. Each of the flow tables can include any suitable dimensions. For example, in some embodiments, each of the vertically stacked flow tables 20 includes a length in a range of about 6 feet to about 10 feet, for example, 6 feet, 8 feet, 10 feet, etc. Each of the vertically stacked flow tables 20 may have similar and/or different dimensions with respect to one or more other vertically stacked flow tables 20 in the vertical farming system 2.

In some embodiments, each of the high-density tables 20 includes an water in-flow system and a water out-flow system. The water in-flow system can include an inlet XA configured to provide in-flow of the water-based nutrient solution 10 from the water tank 12 to a first side of each of the flow tables 20. The water out-flow system can include one or more drains 24 configured to provide out-flow of the water-based nutrient solution 10 from a second side of each of the flow tables 20 to the water tank 12. The one or more drains 24 can include any suitable drain, such as an anti-block drain.

In some embodiments, each of the flow tables 20 is angled and/or inclined from a higher, first side to a lower, second side to allow flow of the water-based nutrient solution 10 from the first side to the second side, for example, due to the force of gravity. For example, in some embodiments, the water in-flow system is configured to provide flow of the water-based nutrient solution 10 to the first side of each of the flow tables 20. The water-based nutrient solution 10 flows down from the higher first side to the second side and is removed from the respective flow table 20 by one or more drains 24 formed integrally with the flow table 20.

In some embodiments, the water-based nutrient solution 10 may be turbulently provided (e.g., “bubbled”) through the inlet XA to a first side 22a of the flow table 20. The water-based nutrient solution 10 is dispersed by the turbulence and flows across the flow table 20 to the second side 22b of the flow table 20 and out-flows through the one or more drains 24. The water-based nutrient solution 10 is provided from the one or more drains 24 back to the tank 12. The water-based nutrient solution 10 is provided at a first temperature from the tank 12. In some embodiments, the temperature of the water-based nutrient solution 10 is maintained at a substantially constant temperature within the flow table 20, for example, by insulation provided by a float board positioned within the flow table 20, as described in greater detail below. In some embodiments, one or more temperature controls are formed integrally with and/or coupled to the tank 12 to maintain the water-based nutrient solution 10 at the predetermined temperature. In some embodiments, the in-flow system and/or the out-flow system includes flushing and filtering systems for the water-based nutrient solution 10.

In some embodiments, the vertical farming system 2 includes a plurality of floats 44 configured to be positioned within each of the flow tables 20. Each of the plurality of floats 44 includes a material configured to float atop the water-based nutrient solution 10 within the float table 20. For example, in some embodiments, each of the floats 44 includes a foam material, although it will be appreciated that any suitable material can be used. In some embodiments, the material of the float 44 is configured to absorb a portion of the water-based nutrient solution 10 and/or to provide insulation to the portion of the water-based nutrient solution 10 positioned beneath the float 44. In some embodiments, each float 44 may be readily modifiable, such as being easily cut, to provide any desired density for particular plants to be grown within the float 44. For example, in various embodiments, each float 44 may include a foam material of a suitable thickness to suspend a growing plant at the desired height above the water-based nutrient solution (e.g., to cause a “stretch” between the roots of the plant and the water-based nutrient solution 10) and/or to sufficiently insulate the plants roots and the water-based nutrient solution 10 from heat generated by overhead lighting, such as the lighting system described in greater detail below. For example, in some embodiments, each of the floats 44 may have a thickness of about 1 to about 4 inches, such as, 1 inch, 2 inches, 2.5 inches, 3 inches, 3.5 inches, 4 inches, etc. Although specific embodiments are discussed herein, it will be appreciated that each of the floats 44 can include any suitable material and be of any suitable dimensions and/or thickness to support a predetermined number of plants at a predetermined height with respect to the flow table 20 and/or the water-based nutrient solution 10 within the flow table 20.

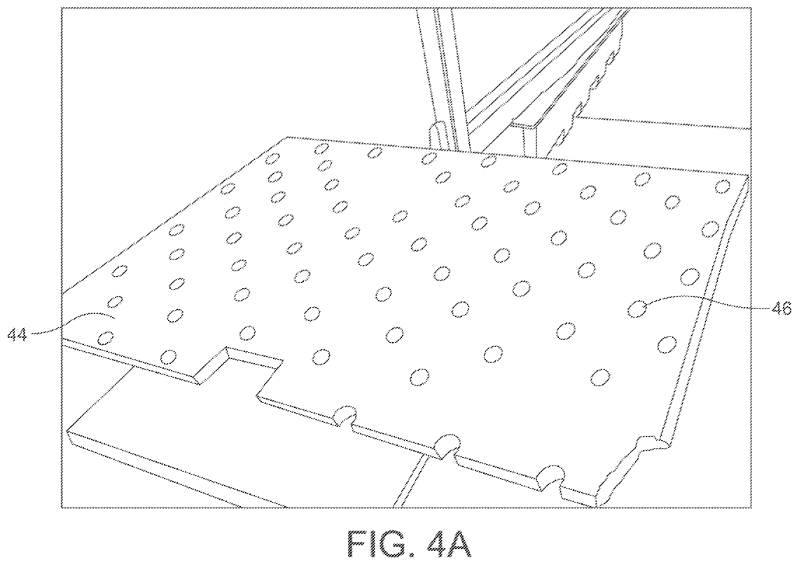

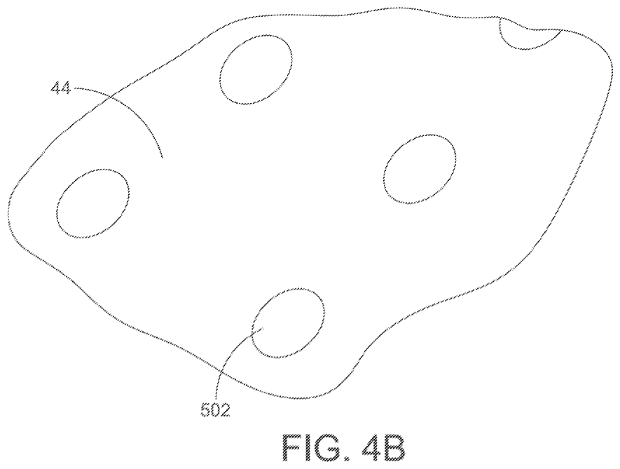

FIG. 4A illustrates a first float 44a, in accordance with some embodiments. The first float 44 includes a rectangular-section of foam (or foam-like) material having a plurality of openings 46 formed therethrough. Each of the plurality of openings 46 is configured to receive a plant and/or a plant retaining element therein. For example, as illustrated in FIG. 4B, in some embodiments, each of the openings 46 is sized and configured to receive a growth medium XB containing at least one plant therein. The growth medium 502 can include any suitable growth medium, such as, for example, volcanic rock wool (also referred to as “rock wool”). In some embodiments, the growth medium is partially inserted through each opening such that a portion of the growth medium extends above and/or below the first float 44a. For example, in some embodiments, a plant seedling may be initially grown in a growth medium 502, such as rock wool, to improve germination of each plant. When each plant reaches a desired height, it may be readily replanted within the float 44a. The openings 46 within the float 44a are configured to receive the growth medium 502 therein and retains the growth medium 502 (and therefore the germinated plant) at a predetermined height with respect to the water-based nutrient solution 10 within a respective flow table 20.

In some embodiments, the first float 44a has a density such that the first float 44a is configured to float on the water-based nutrient solution 10 passing through the respective flow table 20 containing the first float 44a. The first float 44a is able to move in a vertical direction (i.e., up and down) within the flow table 20 as the fluid level of the water-based nutrient solution 10 increases and/or decreases. Movement of the first float 44a maintains the growth medium and/or a plant contained within the growth medium at a predetermined depth within the water-based nutrient solution 10 regardless of the depth of the water-based nutrient solution 10 within the flow table 20.

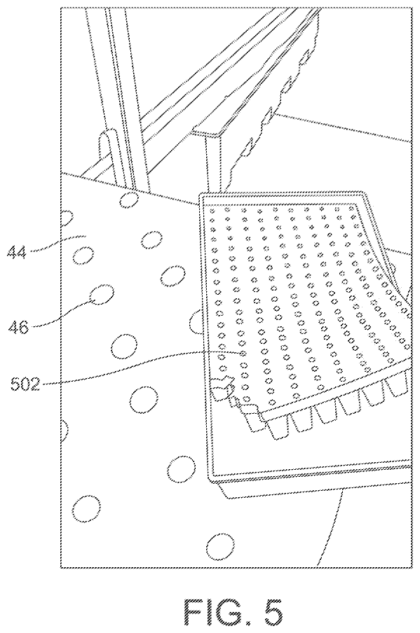

FIG. 5 illustrates a second float 44b, in accordance with some embodiments. The second float 44b is similar to the first float 44a described in conjunction with FIG. 4A, and similar description is not repeated herein. The second float 44b includes a plurality of elongated channels 45 (or containers) configured to receive a growth medium and/or a plant therein. For example, in the illustrated embodiment, the second float 44b defines a plurality of elongated channels 45 each defining a first opening 46 at a first side and a second opening (now shown) at a second side. Each of the plurality of elongated channels 45 is defined by a sidewall 47 extending along an axis perpendicular to a plane defined by the second float 44b. The sidewalls 47 each include a pyramid and/or prism shape such that the elongated channels 45 taper from a widest point adjacent the first opening 46 to a thinnest (or smallest) point adjacent the second opening. Each of the plurality of elongated channels 45 are configured to receive a growth medium and/or a plant therein and maintain the growth medium and/or the plant in a fixed position based on a friction fit between the sidewall 47 and the growth medium/plant. Although specific embodiments are disclosed herein, it will be appreciated that a float board can have any suitable shape sized and configured to maintain growth medium and/or plants at a fixed lateral position within a flow table 20.

In some embodiments, the vertical farming system 2 includes a plurality of lighting systems 40 configured to provide light above, and in close proximity to, each of the flow tables 20. The lighting system 40 may include any suitable type of light-emitting element, such as, for example, induction lighting, light-emitting diodes (LED), organic light-emitting diodes (OLED), and/or any other suitable light emitting elements. In some embodiments, the lighting system 40 is adjustable such that the lighting system 40 and/or one or more elements of the lighting system 40 (such as a light emitting element) may be moved within a plane parallel to a plane of the flow table 20 and/or vertically with respect to the plane of the flow table 20.

In some embodiments, the vertical farming system 2 includes at least one lighting system 40 positioned above each of the flow tables 20 within the vertical stack. For example, some embodiments, each flow table 20 has a single lighting system 40 positioned directly above the flow table 20. In other embodiments, a single lighting system 40 may provide light to multiple flow tables 20 arranged horizontally on a single level of the vertical farming system 2 and/or multiple lighting systems 40 may be arranged horizontally above a single flow table 20.

In some embodiments, the lighting system 40 includes heat-producing induction light elements. Although induction elements have been traditionally avoided in hydroponic farming, the vertical farming system 2 provides several advantages that allow for the use of induction light elements. For example, in some embodiments, each of the floats 44 is configured to insulate a root system of a plant and/or the water-based nutrient solution 10 within a flow table 20 from the heat generated by the induction light elements. The float 44 may be configured such that the root system and/or the water-based nutrient solution 10 are maintained at a predetermined temperature. For example, it is known in the hydroponics field that, for some plants, every 5-10 degrees above 70 degrees Fahrenheit that water/plant roots are heated, oxygenation to the plant may be cut by up to half (resulting in induction lighting being typically disfavored in the art). The use of the heat absorbing float 44 prevents heat transfer to the root system and/or water-based nutrient solution 10, enabling the use of induction lighting without increasing the temperature of the root system and/or water-based nutrient solution 10. The use of heat absorbing floats 44 minimizes the need to make significant adjustments in the proximity of the lights and the temperature of the water for various different crops. In some embodiments, the induction light elements are configured to generate broad spectrum lighting.

In some embodiments, each of the lighting systems 40 is configured to be adjustable in a plane parallel to a plane defined by the float table 20 and/or perpendicular to the plane defined by the float table 20. For example, in some embodiments, each of the lighting systems 40 (or a portion of each lighting system, such as a light emitting element) can be vertically adjusted with respect to the flow table 20. The vertical position of the lighting system may be adjusted using any suitable mechanism, such as, for example, a pulley or pulley system, a catch and/or manual adjustment shelving system, an electric drive system, a hydraulic system, a pneumatic system, and/or any other suitable adjustment mechanism.

In some embodiments, the vertical farming system 2 is configured to be adapted to accommodate growth of any selected crop 102. For example, in various embodiments, the vertical farming system 2 can be adapted by adjustments to one or more of the water-based nutrient solution 10, the in-flow system, the out-flow system, the lighting system 40, the flow tables 20, the floats 44, and/or any other suitable portion of the vertical farming system 2. For example, in various embodiments, one or more floats 44 may be selected to provide a predetermine density for supporting a selected type of plant and/or for insulating the root system of the plant. In other embodiments, the number of tables 20 and/or lighting systems 40 can be increased and/or decreased depending on the space and lighting needs of the selected plant.

In some embodiments, one or more of the float tables 20 includes a cut-off point detector configured to prevent flooding. The cut-off point detector may include a switch or other mechanism configured to cut-off flow of the water-based nutrient solution 10 from the tank 12 if a float 44 within the float table 20 rises above a predetermined level. The cut-off point detector may include any suitable mechanism, such as, for example, a simple mechanical switch, a flooding prevention switch, etc., although it will be appreciated that any suitable cut-off mechanism and/or detector can be used. In some embodiments, the use of a mechanical switch reduces complexity of the vertical farming system 2 as compared to systems using a flooding prevention switch.

In some embodiments, the vertical farming system 2 provides a scalable multi-level hydroponic farming system. As discussed above, the vertical farming system 2 enables the use of broad spectrum lighting, such as induction lighting, without overheating plants. Further, and as discussed above, floats 44 may be employed of any desired depth and density to optimize yield on a crop by crop basis. The height of each flow table 20 and/or the distance of the flow table 20 from the lighting system 40, may preferably be adjustable. The number of platforms, the depth of the float, and the distance from the lighting system for each crop may be entirely adjustable based on the crop being grown.

The vertical farming system 2 enables crops to be grown in almost any indoor farm setting, including, for example, in a “flash farm” or “artisan farm” context. Multi-level farming may be performed in any suitable sized space, such as spaces ranging the size of a single float table and shelving at a single level (for example, about 32 sq. ft.) up to warehouse or industrial scales (for example, 10,000 sq. ft. or more). The vertical farming system 2 allows any person and/or business to engage in indoor farming. For example, restaurants may implement a vertical farming system 2 to engage in their own farming of crops used. As another example, the vertical farming system 2 allows farming to be readily available even in urban areas where space is at a premium. In one embodiment, sixty flow tables 20 may be provided, with each float table 20 being about 8 ft. by 4 ft., requiring as little as 1,600 sq. ft. of space. Although specific embodiments are discussed herein, it will be appreciated that the vertical farming system 2 can be adjusted to fit within any suitable space capable of containing components of the vertical farming system 2 discussed herein.

In some embodiments, the vertical farming system 2 enables the non-use (or elimination) of pesticides and/or animal waste (e.g., animal-based fertilizer), providing heightened cleanliness of the food growing environment (e.g., the facility containing the vertical farming system 2). In some embodiments, various restrictions typically employed in electronics clean rooms may be employed in to maintain the cleanliness of a facility containing a vertical farming system 2. Various methods may be employed to keep out bugs, bacteria, mold, pests, and/or other environmental factors. For example, facilities containing a vertical farming system 2 may have intake restrictions (e.g., no outside food or drink, no outside products, use of sterilized suits, etc.). In some embodiments, cleanliness may be optimized, airlocks may be provided at entry and exit, kosher food protocols may be followed, and/or other controls may be enacted to maintain the environment within a facility. Although specific environments are discussed herein, it will be appreciated that the vertical farming system 2 can be placed in any environment while still providing improved cleanliness and maximum crop yield.

Additionally, as a further advantage, the vertical farming system 2 uses 98% less water than standard (or traditional) farming systems. The vertical farming system 2 enables recycling of the water-based nutrient solution. For example, the use of large, sealed tanks eliminates sources of water loss and/or contamination. Water-based nutrient solution 10 is lost only to plant absorption and minor evaporation. Minimizing evaporation through the relative sealing of the tanks, in conjunction with the increased size of the tanks, minimizes the need to add nutrients or water to the system as compared to previous systems.

In some embodiments, the minimization of water loss and the non-use of animal waste reduces the need to flush the water tank 12. For example, in some embodiments, the water tank 12 and/or the in-flow and out-flow systems for one or more float tables may only need to be flushed and/or cleaned every four to five months, although it will be appreciated that the frequency of cleaning may be dictated by the components of the water-based nutrient solution 10, the types of plants being grown, the environment around the vertical farming system 2, and/or other parameters. Additionally, the reuse of the water-based nutrient solution 10 for extended periods of time prevents contamination of local water systems.

As an additional advantage, the number of human “touch points” in the vertical farming system 2 is appreciably below previous systems. In prior hydroponic and/or non-hydroponic farming systems, the number of human hands that touch food during growth and processing is immense, which can lead to contamination of diseases and/or pathogens, such as Ebola and other food borne diseases. In the vertical farming system 2, each plant is touched only twice, first when implanted in the rock wool and again when removed from the rock wool (i.e., harvested). Cleaning of the plants is unnecessary, due to the heightened clean state of growth and the lack of pesticides and animal-based products. Further, movement or adjustment of the plants is unnecessary due to the adjustable lighting system and/or the use of floats 44, as discussed above.

In some embodiments, the clean state of the water-based nutrient solution 10 allows for “plant improvement” stations. For example, in the event a water-based nutrient solution 10 is not producing plants with optimized growth or flavor, the respective plants may be moved to a cleaning station where a different water-based nutrient solution (having different levels and/or types of components) is provided to clear out plant salts and improve taste. Movement to the plant improvement station does not require human interaction with each individual plant but instead is accomplished by moving the float 44, limiting human interaction to only the float 44. Further, interaction with the float 44 can be limited through the use of tools, gloves, etc. to further limit potential contamination. In some embodiments, movement of lfoats 44 (and the respective plants therein) from one station to another optimizes plant growth, for example, through shelf movement, light changes, float movement, nutrient solution changes, the use of cleanliness stations, lack of need to flush the system, and end stage filtering for nutrient solution flushes.

In some embodiments, the vertical farming system 2 provides exceedingly high density of plant growth. For example, the clean nature of the growth process in conjunction with the use of large, sealed water tanks in the watering system, enables higher density as compared to previous systems. The vertical farming system 2 provides an increase in density of plants over traditional farming methods. For example, in some embodiments, a density increase of over 200 times a traditional farm density (or yield) can be achieved using the vertical farming system 2 (i.e., the yield of a traditional 15-acre farm can be equaled using a warehouse of less than 5,000 sq. ft.). High density growth allows for growth in urban areas, allowing locally grown plants. For example, in the event of a disaster, the vertical farming system 2 enables the availability of food at a point of necessity without needing to bring food from the outside.

In some embodiments, the vertical farming system 2 increases the quality and health of plants grown. For example, because each plant has a balanced water-based nutrient solution 10 that provides predetermined and optimal nutrients, pH levels and the like specific to each plant at an optimal temperature and has an optimal access to air, each plant can grow in an optimal manner. Such optimal plant growth produces optimal taste and quality in grown plants. Moreover, because the suspension of the plants by the float allows the roots of each plant to “reach out” to the water, a low amount of water is needed to optimize the plant growth rate. The plant growth rate may be further optimized based on the use of broad spectrum lighting, as discussed above.

The optimization of plant growth throughout provides several benefits. For example, optimized growth provides maximum yield in minimal time, as well as providing crops that grow at such a high rate of speed that the crops reach maturity that before bacteria and/or parasites have an opportunity to take hold. The vertical farming system 2 enables control of one or more factors for optimizing plant growth. For example, control of one or more factors, such as light, water flow, nutrient components, bacteria and parasites, and/or numerous other factors, either locally or remotely, allows for the providing of different growth rates to match demand, respond to issues, transition between crops, and/or otherwise optimize output of the vertical farming system 2. Further, the vertical farming system 2 allows for growth of plants out of cycle with local and remote outdoor farming. Such ability for staggered harvesting reduces crop competition both for plants produced using the vertical farming system 2 and/or traditional outdoor farming. In some embodiments, a nutrient supply and a water supply can be separated to further prevent crop disease and damage.

In some embodiments, the vertical farming system 2 includes a lighting system 40 having a light enclosure 444 including an iris, in accordance with some embodiments. In prior systems, two principle problems occur due to lighting for indoor growth efforts, mounding and decreased yield. As used herein, the term mounding refers growth of plants towards a stationary light source placed above the plants, resulting in a misshapen growth pattern. Mounding results in uneven plant growth and yield, with plant growth generally being centered largely only directly beneath the light source. Current lighting systems further produce decreased yield due to scorching, burning, or overheating of plants, root systems, and/or water. The heat from a light source may brown or kill plants closest to the light source, due, in part, to the heat emanating from the light source.

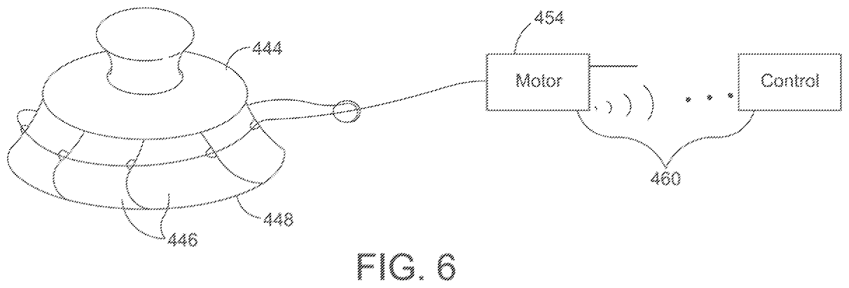

FIG. 6 illustrates a light enclosure 444 configured to prevent mounding and to increase yield as compared to traditional light systems. The light enclosure 444 includes an iris having several overlapping leaves 446, or folds. Each of the overlapping leaves 446 are configured to slidably increase and/or decrease an aperture 448 defined by the light enclosure 444. In some embodiments, the overlapping leaves 446 are mechanically actuated to increase and/or decrease the aperture 448. For example, in the illustrated embodiment, one or more flexible cables 454 are looped about the overlapping leaves 446 defining the aperture 448. In some embodiments, the flexible cables 454 include a first end looped around a respective overlapping leaf 446 and through a first opening and/or eye defined at one end of a flexible cable 454. A second end of the flexible cable 454 is looped through a second opening and/or eye associated with one or more mechanical gears. The gears are configured to pull each of the flexible cables 454 tighter through the eye, thereby decreasing (or closing) the aperture 448 of the light enclosure 444. The gears may be reversed to provide additional slack in each of the flexible cables 454 such that the aperture 448 is increased (or opened). The aperture 448 may be suitably adjusted for any number of factors, such as light to be provided to a crop, distance of the light enclosure from a crop, motion of the light in relation to a crop, heat provided by the light or to the crop, or the like. In some embodiments, the gears are integrated to a control system 460 that may include a motor, pulley, and/or other actuation mechanism and a controller.

In some embodiments, one or more internal features of the light enclosure 444, such as a portion of the leaves 446 adjacent to a light source positioned within the light enclosure 444, may be reflective and/or refractive. For example, in some embodiments, the interior of the light enclosure 444 may be 95-98% reflective and is configured to direct light from the light source through the aperture 448. In some embodiments, the light source is oriented perpendicularly to a plane in which the crops are grown beneath the light source (i.e., a plane of the flow table 20), thereby providing maximum reflection of the light source from the reflective internal sides of the leaves 446. Reflection and/or refraction allows for the use of a lower power light source, decreasing the cost of the light source as well as the likelihood of crop burning due to the heat provided from the light source. In one embodiment, the light source may be in the range of 100-500 watts, for example about 320 watts.

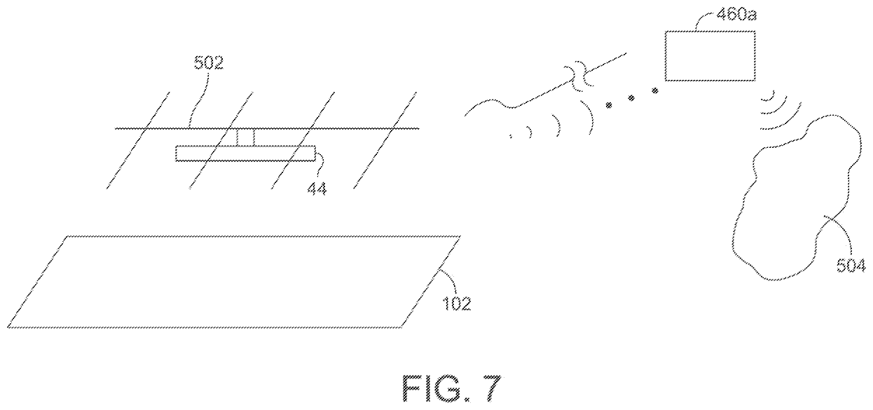

FIG. 7 illustrates a system diagram of a vertical farming system 2a including a lighting system 40a including a light enclosure of FIG. 6, in accordance with some embodiments. The light enclosure 444 is coupled to and configured to move on a mechanical gantry 502 positioned above a flow table 20 containing a plurality of crops 102. The light enclosure 444 may be moved in a predetermined pattern, for example, dependent upon crop type. For example, movement of the light enclosure 444 on the mechanical gantry 502 may be controlled by one or more automated control systems 504. The control system 504 may be the same as and/or distinct from the control system 460 coupled to the light enclosure 444. The control systems 504 may include, for example, one or more local programmable logic controllers, which may be associated with one or more local or remote network controllers.

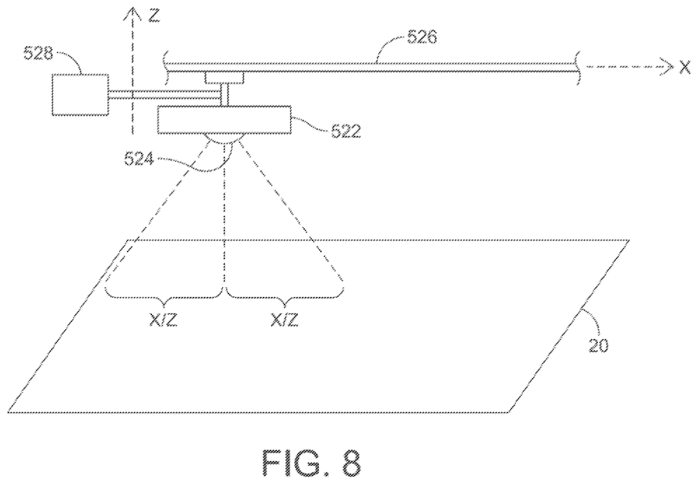

FIG. 8 illustrates a lighting system 520 having an illumination distance X, in accordance with some embodiments. The illumination distance X is the distance between the light source 524 and the flow table 20. The illumination distance X may include any suitable distance, such as, for example, about four feet from the center of the light source 524 to the flow table 20. In some embodiments, the light source 524 is configured to traverse in an automated, predetermined, and/or timed fashion along the X-axis 526. The light source 524 may further be configured to adjust the illumination distance along a Z-axis, for example, using a manual and/or automated Z-axis adjustment 528. In some embodiments, the light source 524 can be adjusted on both the X-axis and the Z-axis.

Adjustment of the light on the X-axis and/or the Z-axis prevents damage to the plants caused by heat and/or excess light. Moving the light source 524 ensures the light source 524 is positioned at a proper height from each particular plant prevents over delivery of heat to the plant, while optimizing light delivery to each plant. Further, movement of the light source may assist in maintaining water temperature at a low value which, as discussed above, minimizes adverse effects of lighting on the plants.

In some embodiments, remote control of the lights, such as via at least one network, may allow for purchase by a grower, lease to a grower, or provision to a grower using a “light subscription”. In a subscription based model, a purchaser may receive lights akin to those disclosed herein, wherein the purchaser may pay for the amount of light used, or may pay for the value of the lights themselves over time, wherein the lighting may be tracked using, for example, the network communications of the lighting system disclosed herein. Moreover, a provider of the lights to the lease may insure against the loss of the lights, and may additionally monitor the use of the lights for compliance with a subscription agreement. In some embodiments, financing may be provided pursuant to a leasing or subscription model.

In some embodiments, a vertical farming system 2a includes networking capabilities 504a configured to allow for both financial and insurance models to be employed. Networking capabilities 504 may further allow for remote monitoring and programming, such as to match lighting to a particular crop, or to monitor for acceptable operation of the lights or to prevent damage to crops.

Additional features might be added to both the motion aspects and the light providing aspects of a vertical farming system 2a, such as in order to optimize crop yield. For example, motion algorithms may be modified over time as optimal motion is learned, such as via the aforementioned monitoring, for particular plant types. Additionally, features such as a randomizer may be added to avoid hot spots that may damage growing crops.

Moreover, because the lighting controls may be wirelessly networked and may thus be capable of wireless communication, the network may provide for additional sensing, such as including light temperature and room temperature. Moreover, wireless lighting controls may allow for the creation of a mesh network using the lighting controls, which may additionally allow for control of individual light aspects via one or more wireless technologies, such as via a mobile device app.

In some embodiments, the turbulence of a cross flow across a flow table 20 may be increased to provide optimal re-oxygenation of a water flow. In some embodiments, multiple drains 24 are provided to accommodate said cross flow. Safety shut off valves may be provided in association with one, some, or all drains 24 to prevent drain jamming and flooding. For example, in some embodiments, between 9 and 11 drains 24 may be provided in each flow bed 20. The drains 24 may be positioned in a staggered manner to ensure that some water flow is maintained at a proper minimal level to optimize plant growth while preventing overflow. In some embodiments, the drains 24 may operate as Venturi drains, i.e. as siphons, thereby maximizing oxygenation of the water.

In some embodiments, the multiple drains 24 are configured to force the plant roots to “stretch” towards the water so as to provide aeroponic growth and optimization of plant health, as discussed further herein below. In some embodiments, the multiple drains 24 allow for high flow and high turbulence break up of anaerobic bacteria, i.e. scum, thereby optimizing crop yield and plant health.

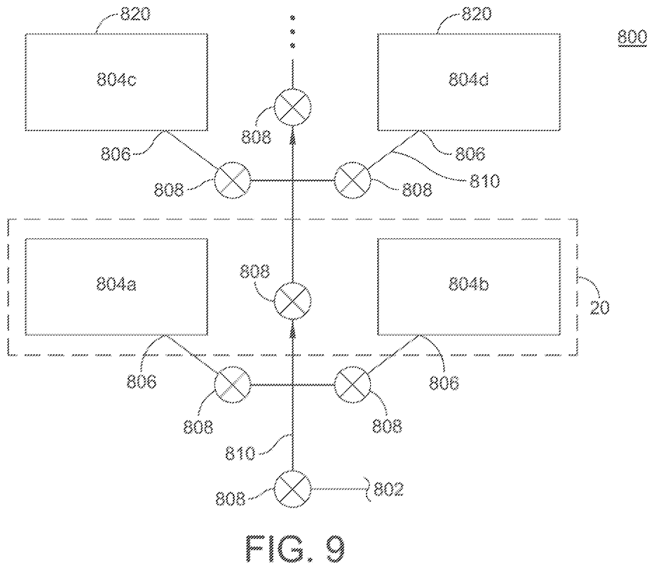

As illustrated in FIG. 9, in some embodiments, a vertical farming system 800 includes a highly modularized system of both water supply 802 and flow tables 804a-804d. The vertical farming system 800 is similar to the vertical farming system 2 discussed above, and similar description is not repeated herein. As referenced herein, modularity encompasses pre-manufactured assemblies that are assembled on site at a growth facility, including preconstruction to allow for expedited assembly of a prefabricated growth facility on site. The vertical farming system 800 includes a partial rack of 4-foot by 4-foot flow tables 804a-804d each on approximately eight foot table shelf 820. As will be understood, each shelf 820 of flow tables 804a-804d thus provides a 4-foot by 8-foot growing area, with each pair of growing trays providing modularized units. Further, and as shown, each 4×4 tray is provided with a water inlet 806, such that each shelf 20 includes two valves 808 and two inlets. The water supply to each flow table 804a-804d, each shelf 20, or sets of shelves may be activated or deactivated by optionally opening or closing individual valves 808. As such, a growing unit, such as an 8-foot rack having four shelves 20, may be modularly deployed or deconstructed.

In some embodiments, the vertical farming system 800 includes a plurality of pipes 810 configured to be coupled via a threaded connection and/or via compression such that the pipes 810 can be releasably coupled to and/or disconnected from a corresponding inlet 806 or valve 808. The releasable pipes 810 allow elements, such as pipes, trays, etc., to be swapped in and out of the system 800 in real time, such as for cleaning and re-swapping at a later point in time, such as monthly. Such maintenance may be performed in, for example, one hour or less. Further, the disclosed modularity may allow for construction of an eight foot rack of shelves 20 in approximately one to three hours or less. The lack of glue avoids the growth of anaerobic bacteria, thereby improving plant health and growth rate.

In some embodiments, the modularity of the vertical farming system 800 facilitates cleaning of pipes and/or trays in a common dishwasher, using peroxide based cleaning, and/or with simple water steam, by way of non-limiting example. This may allow for in situ cleaning of certain modular aspects of the vertical farming system 800, due to the ability to effectively disconnect preselected modules from the water supply.

In some embodiments, the modular maintenance and cleaning discussed herein may additionally aid in pest elimination. For example, mold, mildew, humidity, standing water, and the like, that may attract pests may be eliminated through the regular maintenance and cleaning provided by the vertical farming system 800. Pes elimination may be further supported by constant movement of air and quarantines on entering products and equipment as discussed herein. The use of the vertical farming system 800 eliminates the use of pesticides such that the 50 days typically necessary for a pesticide to grow out of the plant is eliminated. As such, the expedited harvesting methods discussed throughout in conjunction with the advance growth rates referenced herein further support a pesticide free environment.

The placement of each flow table 804a-804d or pair of flow tables 804a-804d per shelf 820 on one or more low profile pallets may allow for ground based harvesting, which is an additional efficiency provided by the vertical farming system 800. For example, a low profile pallet may be fork lifted to ground or table level in order to plan or harvest each individual 4×4 modular flow table 804a-804d, such as after any water supply has been disconnected from the respective tray. As such, in a first step a given flow table 804a-804d may be disconnected from the water supply using the disclosed valves, which consequently allows for the water in the flow table 804a-804d to empty. As a second step, a forklift may then be used to move the pallet upon which a respective flow table 804a-804d rests to a harvest or planting table. After harvesting or seeding occurs, the same forklift may lift the low profile pallet and modularly replace the flow table 804a-804d, at which time the water supply may be reconnected and water may flow. As such, harvest and plant teams may be uniquely created, and downtime for harvesting or planting may be on the order of minutes rather than hours, while the risk of falls, ladders, and the attendant risks in using scissors lifts and the like is avoided.

Thereby, the disclosed embodiments may provide hot swappable, scalable, and/or fully modular, closed indoor farming systems. The flow table 804a-804d may come on and off independently in a single vertical farming system 800, thereby providing scalability and team-based, highly efficient indoor farming.

Further and to optimize and provide process refinement, the vertical farming system 800 may provide unique piping in the modular aspects of the embodiments. The unique piping may allow for enhanced flow, such as to allow full water exchange on all trays of a full rack in one to two minutes or less, which all but precludes the growth of anaerobic bacteria.

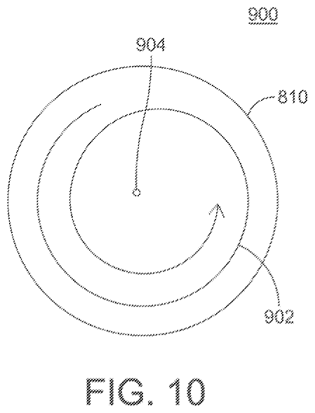

In some embodiments, the piping 810 of the vertical farming system 800 may allow for the creation of a Venturi pressurized system 900 as illustrated in FIG. 10. Each of the flow tables 804a-804d includes a plurality drains 24, which allows for increased water flow across each flow table 804a-804d. The increased water flow, upon reaching downward drain piping, creates a multiplicative spiral 902 within the pipe as illustrated in FIG. 10. The multiplicative spiral 902 enhances the surface area on the outside of the flow and creates an air pocket 904 in the center of the pipe as shown, thus creating a Venturi flow that exposes more of the water to oxygen, enhancing the amount of oxygen that enters into the water. Oxygenation of the water may be further enhanced by, for example, pressurizing the water in the pumping base tank (as discussed above) with additional oxygen and/or increasing the turbulence of the water in the base tank, such as with fans or blowers, by way of non-limiting example.

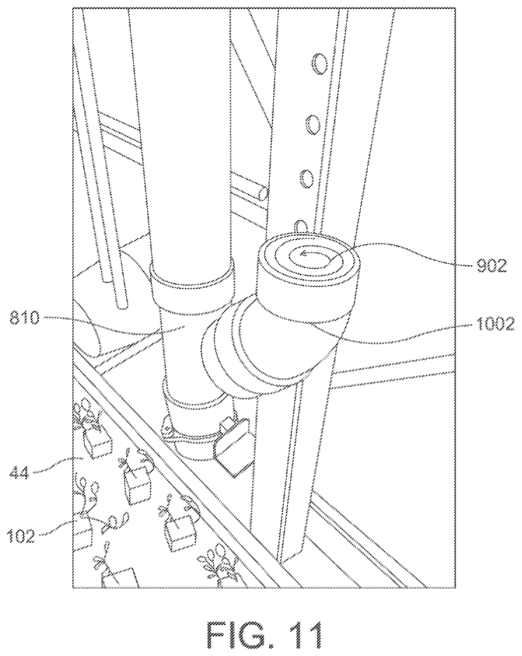

As illustrated in FIG. 11, in some embodiments, the modularity of the piping 810, in conjunction with the Venturi flow within the downward pipes, may readily allow for the location of high-mixing nutrient inputs 1002 along the downward piping, such as whereby nutrients may be readily entered into a nutrient input, mixed by the Venturi flow for entry into the tank, and subsequently pumped back upwards into each modularly operable flow table 804a-804d.

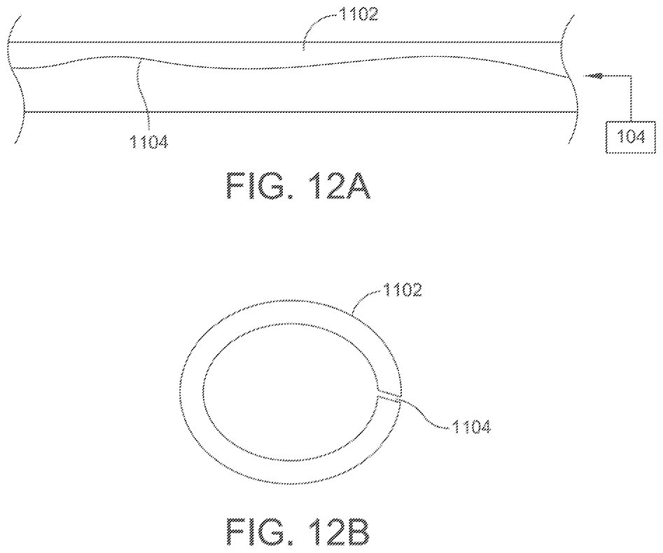

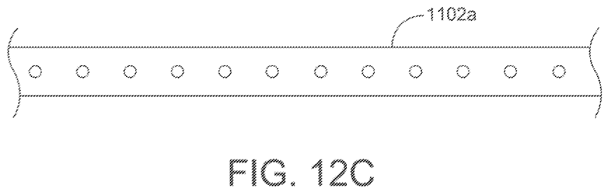

As illustrated in FIGS. 12A and 12B, in some embodiments, the vertical farming system 800 includes spray bars for providing water from the water inlet 104 into each tank, in accordance with some embodiments. The spray bar inlets 1102 may, in some embodiments, have a slit 1104 running lengthwise and at one or more tangent points on the circumference of the spray bar 1102. More particularly, the slit 1104 may run the full and/or partial length of the spray bar, may or may not be uniform from the center point of the mean high water line on the pipe along the length of the spray bar, and may or may not be comprised of a uniform cut or cuts, both in cut size and/or cut angle, along the length of the slit 1104. The slit 1104 generates a uniform water spiral within the spray bar 1102 prior to exit of the water from the slit 1104, providing enhanced water flow uniformity across the flow table 804a-804d and increases turbulence in the flow within the spray bar 1102 to additionally enhance the water content of the water flowing across the flow table 804a-804d. FIG. 12C illustrates an embodiments of a spray bar having a plurality of openings.

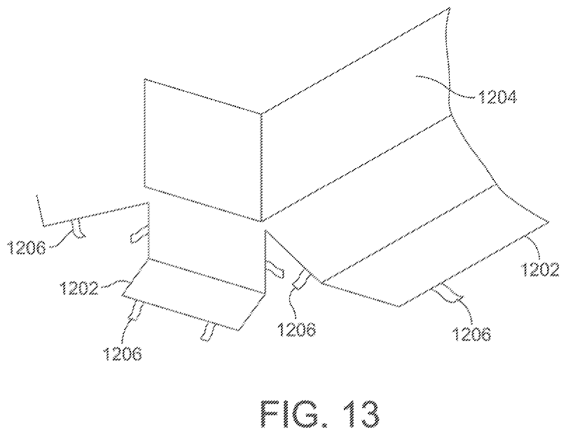

Further and by way of non-limiting example, maintaining the water in supply tanks at a low temperature, such as 68°, may further prevent overheating of plants, including by serving as a heat sink for the room. To minimize the possibility that the water temperature will be undesirably raised, FIG. 13 illustrates a tank cover 1202 that may protect the tank 1204 from gaining or losing heat, and that may be comprised of heat reflective material, such as that included in oven mitts. The tank cover may additionally have hook-and-loop, or a like ready-fastener/unfastener 1206, to allow for simplistic attachment of the cover 1202 to the contours of the tank 1204, and which may further allow for simplistic removal of the cover 1202 from the tank 1204, such as to allow for washing of the cover 1202.

The controls and sensing discussed throughout may further include optimization of the enthalpic moment for the growing environment. That is, various embodiments of the vertical farming system 800 may, using each individual plant and algorithms specific to certain plants and environments applied by one or more computer processors, provide an optimized window of a plant's needs for optimized growth. In short, an optimized enthalpic moment may have a large number of contributing variables, but principal among these variables are water (which includes bacteria and nutrients), CO2, and light. Through assessment of variables correspondent to at least the foregoing three, and, in preferred embodiments, additional variables, the algorithms may correlate the variables over a particular range to obtain an enthalpic moment of optimized growth for individual plants. Such calculations may additionally include, by way of example, the energy provided by manual laborers typically present in a room, energy provided by computers in a room, energy produced by light wattage, energy or gases absorbed by enhancing turbulence in water flow, and the like.

Manipulation of variables to obtain an optimal enthalpic moment may allow for minimization of the use of heating or air conditioning in a given environment. For example, in light of a plant's needs, variables may be controlled with a target point for environmental temperature and humidity. Maintenance of temperature and humidity at a preferred steady state, while providing at least minimum quantities of water, CO2, and light, may optimize plant yield and minimize failures.

Accordingly, while sensors may be used to provide data to one or more computer processors applying the disclosed algorithms a current state of each of the variables discussed herein, environmental definition and control may be modified from the known art. For example, environmental controls may be defined by an enthalpy factor, wherein the environment is to be maintained for optimal plant growth within a particular tolerance of a given enthalpy factor for the growing then underway.

Further, the use of an enthalpy factor allows for the definition of an energy value on a per plant basis to maintain a given enthalpy factor. Such energy value may include, by way of non-limited example, the capture of heat by each plant from one or more lights to which the plant is subjected, the effects of sunlight on energy consumption on a per plant basis if lights are only used periodically or at night, and stray energy within a room that may be captured and rededicated to plant growth.

As additionally referenced herein, the interconnectivity, such as via a mesh network, of a growth facility in accordance with the embodiments may allow for generation of significant data sets, which enable expedited artificial intelligence learning capabilities. That is, to simply maintain temperature and humidity in a typical growth facility, 30 variables must be monitored manually. The three-dimensional data set generated by the embodiments allows for automated learning to balance and weight these 30 variables, such as on a plant by plant or facility by facility basis, in order to uniquely optimize growth for each plant and each facility. These significantly advanced data sets, which may be accumulated across multiple facilities, such as tracked by facility and/or plant growth type, allows for nearly unlimited scalability in the embodiments. The scalability allows for expedited timing to get a growth facility up and running, and, such as in conjunction with the pesticide free growth discussed herein, and the modularity discussed herein, can allow for tripling or quadrupling of yield per square foot in a facility as a consequence of the scalability and upward build of the modular platform provided herein.

These advanced data sets may be generated by mesh, Raspberry, or similarly interconnected networked elements. Such elements may include, for example, stationery, movable, or drone based cameras, such as visual spectrum or infrared cameras, that allow for data tracking of plants in various locations and at varying heights; device timers; air-conditioning and humidity control; pumping and water chilling; lighting, and so on. In conjunction, these data sets may allow for pattern recognition by the artificial intelligence provided in accordance with the embodiments. This pattern recognition may allow for modification of any one or more variables to achieve desired results for particular plants, particular facilities, and so on.

In some embodiments, water-based chillers may be employed, such as to distribute chilled water to the reservoirs discussed herein, and to at least partially control air temperature in the facility. The use of chilled water may decrease the BTUs necessary to cool a facility by 5 to 10 times. Further, additional data points made available by the use of water chillers may include known humidity in a facility based on plant transpiration, as the use of chilled water results, in part, in the removal of humidity from a facility thereby allowing for an indication to the artificial intelligence that remaining humidity in the facility is being generated principally or solely from plant growth. Of note, the chillers discussed herein may be solenoid based, and solenoid's may be distributed as between multiple tanks, or may be resident only in, for example, a center tank among 3 tanks. Longer solenoids are desirable, at least in that the additional surface area generated by a longer solenoid, such as more of the water surface, thereby resulting in enhanced chilling.

In some embodiments, the distribution of chilled water, such as is referenced above, further allows for control of plant growth. For example, in some embodiments, the chilled water provides “air-conditioning” at the roots of the plants that extend down into the tanks containing the distributed chilled water, allowing for temperature and transpiration monitoring of the plant, to thereby allow for a correlation of plant health, transpiration, and system operation. This correlation may include, for example, all data points available on the platform, including those generated by the hardware discussed herein, such as by drones, cameras, infrared, or the like. The use of infrared monitoring may allow, for example, as part of this calculation, the generation of BTUs by people within a facility, the monitoring of the temperature and amount of airflow, and the infrared monitoring of lights, water, and other elements that provide a temperature indicative of proper operation.

In some embodiments, a vertical farming system 800 can be configured for optimized water growth, including in the use of rapid deep water culture. For example, a check valve may be included, such that when, based on the modular piping provided, a pump is turned off, water is blocked from siphoning from the upper trays back into the tank, thereby preventing plant damage. This check valve may operate based on the physics of the water flow as the siphon against a form, or may include an automated valve that is actuated by the system based on a pump shutdown. The check valve employed may be, for example, a 2 psi check valve.

Further, lights may be variously controlled to allow for deep water growth. For example, lights may automatically move up, down and sideways, and may provide for multiple planes of plant growth through the use of variable lighting. Additionally, multiple lights may be simultaneously or hierarchically employed.

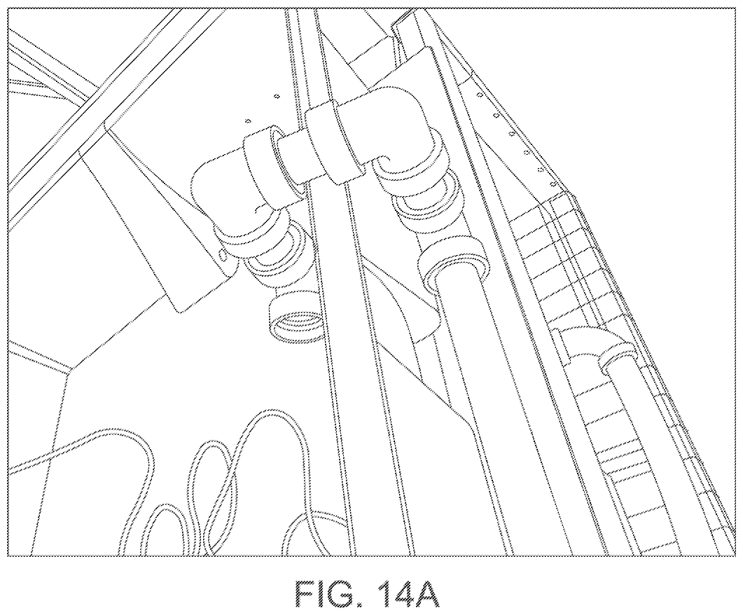

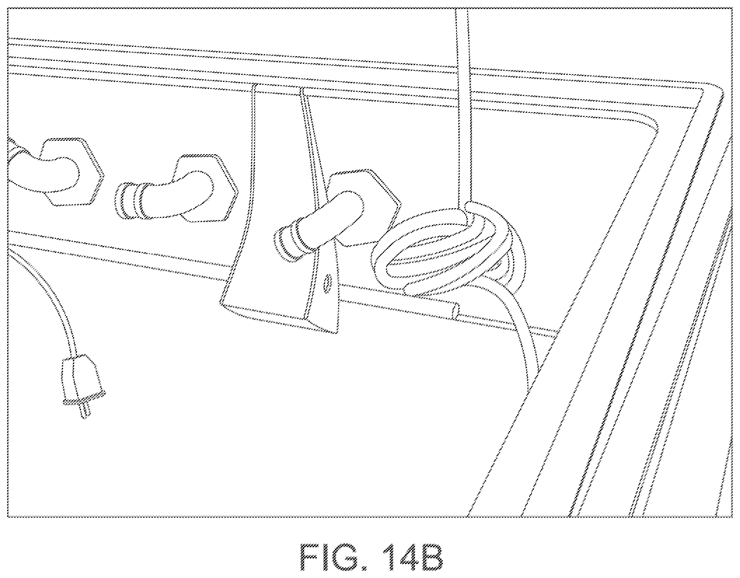

In some embodiments, water controls may be provided specifically for rapid deep water culture growth. For example, water inlets may be provided with rotatable piping, such that the water may be aimed upon inflow to cause root growth in a particular direction, such as to avoid the blockage of drains. Likewise, one or more directional drains may be provided in order to “aim” drains away from root growth, such as away from the directionality of the inlet water. FIGS. 14A and 14B illustrate rotatable water inlets, and drains, respectively, that allow for manual water flow control.

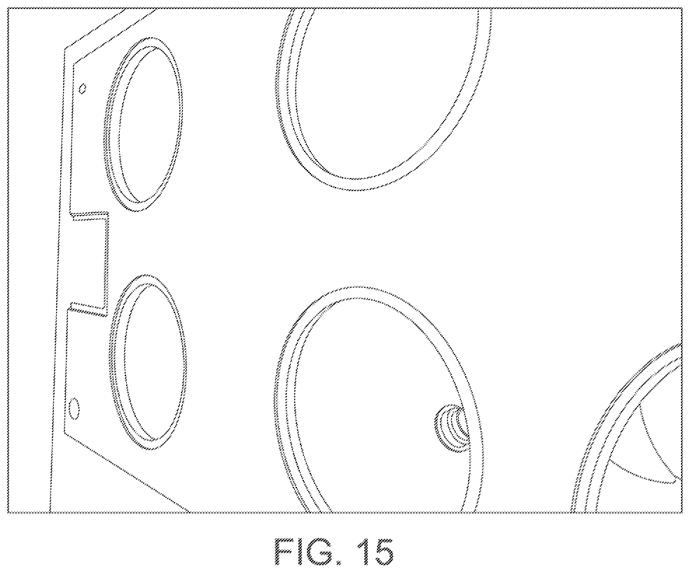

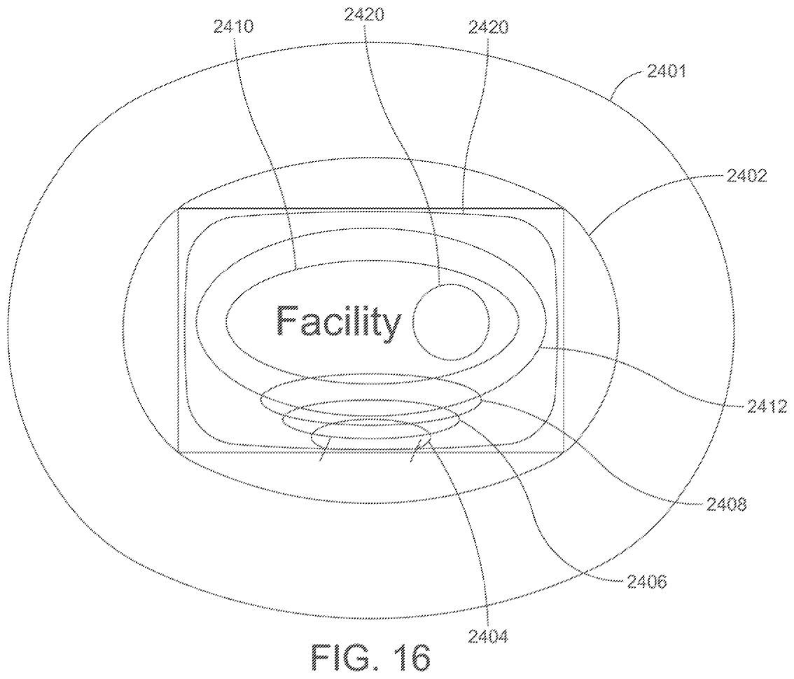

FIG. 15 illustrates one embodiment of a “growth board” that may or may not float atop the water as disclosed herein, but that includes one or more cutouts. These cutouts may allow, by way of non-limiting example, for the insertion of a hand in order to manually rotate the inlet and/or drain piping as discussed above. Of note, plants that may be subjected to rapid deep water culture growth may include, by way of non-limiting example, sunflowers, tomatoes, cannabis, peppers, poppies, and so on.

In some embodiments, a pesticide, fungicide, and herbicide free environment may be created by the conceptual creation of anti-pest “zones” beginning outside of the growing facility 2401, 2402 and terminating at the point of growth, as shown in FIG. 16. For example, anti-pesticide paint may be used outside and inside of the growth facility. Upon entry to the growth facility, a person may be subjected to a vestibule 2404, such as may douse the person with water, high-pressure air, physical brushing, or the like. This vestibule may also be a zone 2406 for changes of clothing for the entering person. Furthermore, the vestibule may include one or more “blue lights”, or similar lighting 2408, to kill and/or help with the detection of pests.

Once departing the vestibule, the person may enter an organism-based clean room 2410. No food or drink may be allowed in the clean room, and the temperature control may be comfortable for plants and people, but may be adverse to pests, such as based not only on temperature, but also on humidity. Such growing methodologies may additionally allow for kosher and/or medicinal growth. For example, the vestibule mentioned above may include a changing room that may include a shower, the need for a person to clothe him or herself in a bunny suit, hair covering, negative airflow, laundry services, and so on. Also included may be particular filtration systems 2410, such as ozone, CO₂, carbon based, HEPPA, and the like, which may not only eliminate pests but may additionally aid in plant growth.

In addition to climate controls, once a person is within the growing area, other pest elimination techniques 2420 may be employed. For example, the anti-pest paint mentioned above may be used, as may be sticky pads to capture pests, nematodes to kill bug eggs, plant friendly killer bugs, such as lady bugs and praying mantis, and terminator plants, such as may eat pests. It goes without saying that certain of the foregoing, such as nematodes, killer bugs, and terminator plants may require replacement at regular cycles due to a lack of food if the environment is indeed maintained as past free.

In some embodiments, the vertical farming system 2 is configured for micro-climatization and/or micro-control of one or more growing environments. A refined temperature and humidity control systems may be used in conjunction with a lighting system, such as the lighting systems 40, 40a described herein in predetermined portions of a growth environment. For example, in some embodiments, humidified and/or dehumidified micro-environments are provided within the same growth area. As another example, in some embodiments, high-light, low-light, and/or multiple light cycles are provided within the same growth area.

In some embodiments, a control system, such as one or more of the control systems 460, 504 discussed above, is integrated with one or more sensors and/or sensing systems configured to monitor temperature, humidity, infrared (e.g., heat), and/or other environmental factors in one or more predetermined micro-environments (or pockets) within the growth environment. The control system is configured to provide monitoring of the growth environment and/or predetermined micro-environments within the growth environment based on input from the one or more sensors and/or sensing systems. For example, in some embodiments, one or more sensors, such as infrared cameras, are configured to monitor infrared output (e.g., infrared signatures). The input from each sensor is processed by the control system to identify infrared signatures associated with individual insects and/or insect nests. Although specific embodiments are discussed herein, it will be appreciated that the control system can be configured to monitor any suitable input for identifying any suitable parameters, such as, for example, plant health, insect presence, crop yield, etc.

In some embodiments, the control system is configured to apply one or more data manipulation techniques to refine input from the one or more sensors and/or sensing systems. For example, in the embodiment discussed above including infrared monitoring for insetcs, the signal to noise ratio of the data generated in comparison to the data signifying an insect may be high. Eigen-value or Eigen-vector manipulation may be performed on data received from the one or more sensors to identify the data representative of (or significant to) an insect or insect nest.

In some embodiments, the control systems is configured to use a combination of micro-data (i.e., data pertaining to one or more micro-environments) and macro data (e.g., data pertaining to the entire growth environment) to monitor the growth environment and/or the micro-environments. For example, macro data may be used to analyze the presence of people, the temperature of a given set of plants, or the like. Micro-data may be used to assess the presence of bugs, the presence of warm-blooded and/or cold blooded creatures, or the like. A combination of micro and macro filtering may be employed to assess, for example, humidity and temperature, including microclimate and/or macroclimate humidity and temperature.

In some embodiments, the control system and associated micro-environments discussed herein allow various greenhouse environments to be selectively provided within the growth environment, for example, within only one or more micro-environments. In some embodiments, the lighting system 40, 40a is configured to provide light within one or more micro-environments according to a predetermined schedule, such as, for example, only during hours of darkness. In some embodiments, the vertical farming system 2 is configured to block light from passing through particular greenhouse panels (or into portions of the macro-environment), for example, by using shades, glass darkening, and/or other light blocking techniques. The control system can be configured to selectively darken micro-environments within the macro-environment while allowing light to pass through other greenhouse panels and/or portions of the greenhouse. Further, humidity and temperature may be controlled and modified in conjunction with one or more macro-environment controls, for example, covering/uncovering and/or opening/closing of greenhouse windows. Each microclimate and/or macro growth environment may be treated as one or more closed systems, in which the growth of one or more plants may be monitored and controlled. In various embodiments, the control system is configured to control one or more micro-environmental controls, one or more macro-environmental controls, and/or a combination of both micro and macro-environmental controls.

In some embodiments, the macro-environment includes a plurality of micro-environments each corresponding to one or more layers within the vertical farming system 2. For example, a canopy provided by an upper-level growth may minimize the passage of light to and decrease the temperature of lower growth climates in a multilevel vertical farming system 2. The control system may be configured to isolate micro-environments within the vertical farming system 2 to advantageously position one or more crops in view of environmental performance, such as with respect to humidity, based on the choice of crops placed at each level of the vertical farming system.

Ultimately, the foregoing may allow for significantly more harvest per square foot than in known embodiments, including in known basic greenhouse embodiments. Such enhanced harvests may require little to no additional energy or costs over the decreased numbers of harvests available in the prior art. The performance of the disclosed growth systems, without need for additional energies, may be enhanced using other methodologies, such as the use of cool groundwater (approximately 57°) as a natural chiller system, whereby the use of cool groundwater helps to maintain water distributed to plants at 68° for optimal growth without the need for the disclosed chiller systems. Further, artificial lighting that generates little to no heat may be employed during darkness, or like deprivation periods, such as in order to avoid the need for cooling the ambient environment. Such artificial light systems may generate no heat because the light is generated at resonant frequencies, and as such is minimal and heat generation, or using other known methods of decreased heat lighting.

Also, as referenced throughout, not only the energy consumption, but additionally, the maintenance required by the disclosed system provides significant improvements over the known art. For example, much of the prior art employs non-modular steel or metallic piping, which decays, rusts, incurs mold and mildew, and requires significant maintenance, such as through the use of detrimental chemicals. Further, much other prior art may employ conveyor belts for crop movement, permanent glues and sealants, and the like, which may require the replacement of conveyors, the cutting of pipes, and the like, in order to perform cleaning and maintenance. On the contrary, the disclosed embodiments allow for regular maintenance cycles, such as in which the modular nature of the pipes allows for removal and cleaning without allowing for the decay of pipes or the use of harsh chemicals. The foregoing allows for more frequent maintenance, and hence cleaning, than in any prior art embodiments. Further, it allows for a relatively steady nature of a required maintenance algorithm in the use of the embodiments, i.e., the maintenance cycle is consistent over a longer periods of time than is the case in the known art. This is more clearly illustrated with respect to the graph of FIG. 18.

The aforementioned further allows for the training and education of cleaners who may, for example, travel in small numbers as a team in order to expediently clean and maintain various different facilities. That is, the embodiments allow for the maintenance of a farm without decay over great periods of time with simplistic and expedited cleaning at minimal cost because of the modular nature of the disclosed embodiments. This is distinctly contrary to the known art, in which the productivity of a facility decays greatly over time, and operating costs, particularly as it relates to maintenance and cleaning, skyrocket in the event a facility is to be carefully and properly maintained.

The disclosed microclimates referenced herein further may allow, such as in conjunction with the referenced control and monitoring and filtering systems, and the disclosed variable maintenance cycles, for the development of unique strains optimized to the disclosed growth systems for crops grown. For example, refined control of insects, humidity, temperature, nutrients, carbon dioxide, and water within each of a given group of microclimates may allow for the matching of a crop growth within that microclimate to the growth system. As such, crop strains may be optimized or modified to match up with a given growth microclimate targeted to maintain optimized performance for that crop strain.

The embodiments may, as discussed throughout, employ one or more chillers in order to maintain optimal water temperatures between 62 and 74°, and most preferably at approximately 68°. These chillers may be comprised of, for example, two coils that may be thermostatically controlled by solenoids present at the nutrient bath distribution tanks discussed herein, wherein each such tank may be uniquely associated with each growing rack, portion of a growing rack, or multiple growing racks. More particularly, rather than the typical “spring coiled” solenoid that may be, for example, associated with a chilling system, the embodiments may employ two lengthened “corkscrew” solenoids that are extended substantially across opposing sides of a tank, such as is shown in the top view of FIG. 16. Such a temperature distribution solenoid system may avoid the creation of temperature pockets, that is, it may allow for enhanced temperature distribution across a water tank. Needless to say, and as discussed throughout, enhanced control of water temperature allows for optimal crop growth in association with the embodiments.

As is generally the case, the chilling system may then include a return line from the tank back to the chiller. In typical prior art embodiments, decoupling pipes are employed between the tank and the chiller return. However, the embodiments may instead employ one or more decoupling reservoirs, as is shown in FIG. 17. This may provide advantages over the known art, such as wherein leak assessment may be readily performed by adding coloring to the decoupling tanks, by way of nonlimiting example. Further, decoupling tanks may be employed in a one-to-one, multi-to one, or one to multi-relationship, such as wherein 3 decoupling tanks are associated with 3 chillers. Moreover, the disclosed system may allow not only for the chilling of water, but the warming of water using the same system as disclosed throughout.

As referenced, the foregoing, an additional disclosed systems may allow for a closed system in the embodiments. In a closed system, pressure may be maintained in the disclosed systems, such as using the valves referenced herein, in order to avoid backflow. That is, pumps and valving may be employed to adapt to environmental changes, such as including temperature changes, using the disclosed system. Additional benefits may be provided by a closed system, such as substantially accurate humidity control. For example, a closed system that includes dehumidifiers may allow for the removal of humidity as needed in order to maintain a particular humidity set point.

As mentioned, farming may thereby be performed even in urban areas, or within businesses, such as restaurants. Accordingly, artisan farmers may engage in their own farming and/or may license the right to employ the apparatuses, systems and methods discussed herein. Similarly, businesses may engage in farming on site, and may hire third parties to come in and service the farm on an as-needed basis, or at pre-determined intervals, in a manner akin to office coffee service replenishment systems that are known in the art.

Moreover, it can be seen that various features may be grouped together in a single embodiment during the course of discussion for the purpose of streamlining the disclosure. This method of disclosure is not to be interpreted as reflecting an intention that any claimed embodiments require more features than are expressly recited in each claim that may be associated herewith.

What is claimed is:

1. An indoor farming system, comprising:
a water-based nutrient bath resident in a tank;
a pump for pumping the bath from the tank upwardly through a plurality of pipes to at least one divided high-density table comprising growing crops resting in at least one float;
the plurality pipes comprising at least one valve suitable to shut off the bath per each of the high density tables;
at least one non-block drain on each divided one of the tables, wherein the bath turbulently flows respectively across each of the divided tables and down the at least one non-block drain based on at least gravity, and then back into the tank that includes the nutrient bath; and
a lighting system that provides moving light from points above the growing crops.
